(19) United States
(12) Patent Application Publication
(10) Pub. No.: US 2017/0037199 A1
(43) Pub. Date: Feb. 9, 2017

(54) COMPOSITION AND METHOD FOR COMPOSITE MATERIAL IMPREGNATED WITH SEMI-CRYSTALLINE POLYAMIDE, OBTAINED FROM A PREPOLYMER AND A CHAIN EXTENDER

(71) Applicant: Arkema France, Colombes (FR)

(72) Inventors: Gilles Hochstetter, L'hay Les Roses (FR); Thierry Briffaud, Bernay (FR); Mathieu Capelot, Bernay (FR)

(73) Assignee: Arkema France, Colombes, OT (FR)

(21) Appl. No.: 15/304,676

(22) PCT Filed: Apr. 15, 2015
(86) PCT No.: PCT/FR2015/051017

§ 371 Date: Oct. 17, 2016

(30) Foreign Application Priority Data
Apr. 15, 2014 (FR) 14 53349

(51) Int. Cl. C08J 5/04; B29C 70/52; C08G 69/48; B29C 70/48; C08G 69/26; C08G 69/28

(52) U.S. Cl. CPC C08J 5/04; C08G 69/265; C08G 69/28; C08G 69/48; B29C 70/48; B29C 70/52; C08G 2120/00; C08J 2377/06; B29K 2077/00

(57) ABSTRACT

A molding composition including at least one semi-crystalline polyamide derived from the polyaddition of a) at least one polyamide prepolymer bearing n identical functions X chosen from carboxyl, amine and hydroxyl, and of b) at least one non-polymeric reactive extender bearing two identical functions Y that are reactive with said functions X with n ranging from 1 to 3, the polyamide and prepolymer a) including 55 mol % to 95 mol % of amide units A, 5 mol %-45 mol % of amide units B with A corresponding to x.T in which x is a linear aliphatic C9-C18 diamine and B corresponding to x′.T in which x′ may be B1): specific branched aliphatic diamine dependent on x or B2): MXD or B3): linear aliphatic diamine which depends on x, the polyamide having a Tg of at least 90° C. and a Tm of less than or equal to 280° C.

The invention relates to a specific non-reactive molding composition, in particular for a thermoplastic composite material with a matrix of semi-crystalline polyamide (PA) having a glass transition temperature Tg of at least 80° C. and preferably of at least 90° C. and a melting point Tm of less than or equal to 280° C., this polymer having a specific structure, and also to a process for manufacturing said composite material, in particular mechanical or structural parts based on said material, to the use of the composition of the invention for composite material parts and also to the composite part which results therefrom and for applications in the motor vehicle, railway, marine, road transport, wind power, sport, aeronautical and aerospace, construction, panel and leisure fields.

EP 0 261 020 describes the use of reactive semi-crystalline prepolymers based on PA 6, 11 and 12 for the manufacture of a thermoplastic composite by means of a pultrusion process. The prepolymers of aliphatic structure as described have low Tg values and insufficient mechanical performance qualities at elevated temperature.

EP 2 586 585 describes a process for manufacturing a composite material with fibrous reinforcement, comprising the impregnation of said fibrous reinforcement with a precursor reactive composition of a thermoplastic polymer, said precursor composition comprising a reactive prepolymer P(X)n and a chain extender bearing two functions Y that are reactive with the functions X of said prepolymer. However, no bulk melt impregnation with the final thermoplastic polymer thus obtained is described or suggested, nor is any associated advantage.

EP 550 314 describes, among its examples, (non-reactive) copolyamide compositions in a search for melting points above 250° C. and limited Tg values, with the majority of the cited examples having an excessively low Tg (<80° C.) or an excessively high Tm (>300° C.).

EP 1 988 113 describes a molding composition based on a 10T/6T copolyamide with:

40 to 95 mol % of 10T

5 to 40 mol % of 6T.

Polyamides with a high melting point above 270° C. are targeted in particular. The examples mentioned and FIG. 1 teach that the melting point of these compositions is at least about 280° C.

WO 2011/003 973 describes compositions comprising 50 mol % to 95 mol % of a unit based on a linear aliphatic diamine comprising from 9 to 12 carbon atoms and terephthalic acid and from 5% to 50% of units combining terephthalic acid with a mixture of 2,2,4- and 2,4,4-trimethylhexanediamine.

US 2011306718 describes a process for the pultrusion of low-Tg reactive aliphatic polyamides combined with chain extenders having a polymeric structure bearing several (and much more than 2) anhydride or epoxide functions. This document describes no non-polymeric extender.

The drawbacks of the prior art with the absence of a good compromise between the mechanical performance and the proccessability (ease of transformation) at lower temperature with a shorter production cycle time are overcome by the solution of the present invention which targets semi-crystalline PA compositions, allowing easier processing at lower temperatures with a saving on the overall energy balance for the processing process, a shorter production cycle time and improved efficiency via rapid crystallizability of said polyamide polymer while at the same time maintaining a high level of mechanical performance for said final materials.

The specific choice of a semi-crystalline polyamide polymer, as matrix of the composite material of the invention, has the advantage, compared with amorphous polyamides, of significantly improved mechanical performance levels, especially at elevated temperature, such as creep resistance or fatigue resistance. In addition, having a melting point above 200° C. has the advantage in the motor vehicle industry of being compatible with treatments by cataphoresis, which a structure of amorphous PA type does not permit. As for amorphous materials, a Tg of greater than or equal to 80° C., preferably at least 90° C., is sought so as to ensure good mechanical properties for the composite over the entire working temperature range, for example up to 80° C., preferably at least 90° C. for the wind power sector, up to 100° C. for the motor vehicle sector and up to 120° C. for the aeronautics sector. Conversely, a melting point that is too high, in particular above 280° C., is on the other hand detrimental since it requires processing of the composite at higher temperatures with constraints in terms of molding material to be used (and associated heating system) and overconsumption of energy with, in addition, risks of heat degradation due to heating at temperatures higher than the melting temperature of said polyamide, with, as a consequence, an effect on the properties of the final thermoplastic matrix and of the composite which results therefrom. The crystallinity of said polymer must be as high as possible, but with a melting point Tm that is not too high (Tm ≦280° C. and more particularly ≦270° C.) in order to optimize the mechanical performance and the crystallization rate and/or the crystallization temperature must be as high as possible, in order to reduce the molding time before ejection of the molded composite part with a selective choice of the composition of said semi-crystalline polyamide. Consequently, the subject of the present invention is the processing of novel specific compositions of thermoplastic composite, in particular based on semi-crystalline polyamide, having a good compromise between high mechanical performance levels (mechanical strength), in particular at elevated temperature, and easy processing. This means that the objective is compositions that are easy to process with transformation and processing temperatures that are lower than those for other compositions of the prior art, with a more favorable overall processing energy balance, a shorter cycle time and a higher productivity. More particularly, the polyamide polymer matrix, while having a high Tg and a limited Tm as defined, with easy processing of said composite, must also have a high crystallization rate, characterized first by a difference between the melting point and the crystallization temperature Tm-Tc not exceeding 50° C., preferably not exceeding 40° C. and more particularly not exceeding 30° C. More preferentially, this difference Tm-Tc does not exceed 30° C., unless Tm-Tg is <150° C., in which case (Tm-Tg <150° C.), the difference Tm-Tc may range up to 50° C. The mechanical performance or mechanical strength at elevated temperature of the composite may be evaluated by the variation of the mechanical modulus between room temperature (23° C.) and 100° C. with maintenance of at least 75% of the mechanical performance, in terms of modulus, relative to that at room temperature (23° C.). Thus, the object of the invention is to develop a polyamide composition that satisfies these needs. The specific polymer of the invention, having the characteristics indicated above, is derived from the polyaddition reaction of a polyamide prepolymer a) with a non-polymeric extender b). More particularly, this specific semi-crystalline polyamide polymer, used according to the present invention for the bulk melt impregnation of a fibrous reinforcement for the preparation of a thermoplastic composite material, has the additional advantage of having easy processing with improved fluidity, i.e. a melt viscosity at the same temperature for the impregnation of said fibrous reinforcement that is lower than that of the same polyamide but without incorporation of said extender b) (only difference) and also with the advantage of having at the start a high and precontrolled molecular mass Mn before the step of impregnation of said fibrous reinforcement without high viscosity.

The first subject of the invention concerns a specific non-reactive molding composition of semi-crystalline polyamide (PA) for a thermoplastic composite material, said polyamide having a Tg of at least 80° C., preferably at least 90° C. and a Tm of less than or equal to 280° C., preferably less than 280° C. with said semi-crystalline polyamide polymer of said composition being a non-reactive polymer and derived from a polyaddition reaction between a) at least one reactive polyamide prepolymer of said semi-crystalline polyamide, bearing n identical reactive functions X from among amine, carboxyl and hydroxyl, preferably carboxyl or amine, with n ranging from 1 to 3, preferably from 1 to 2 and more particularly 2, and b) at least one non-polymeric chain extender Y-A′-Y with identical functions Y that are reactive with said functions X of said prepolymer a), with Y preferably being chosen from: oxazine, oxazoline, oxazolinone, imidazoline, epoxy, isocyanate, maleimide, with said semi-crystalline polyamide and prepolymer a) being of specific structure based on specific and different units A and B, with the presence of units C and/or D.

The invention also relates to a process for manufacturing a thermoplastic composite material using said specific polymer of the invention for impregnating a fibrous reinforcement.

Finally, the invention relates to the use of said non-reactive molding composition or of said polymer according to the invention contained in said composition, for the melt impregnation of a fibrous reinforcement as thermoplastic matrix of a composite material, for the manufacture of mechanical parts or structural parts of said composite material.

Thus, the first subject of the invention concerns a non-reactive molding composition, in particular for a thermoplastic composite material, comprising at least one thermoplastic polymer and optionally reinforcing fibers, also referred to hereinbelow as fibrous reinforcement and, in this case, said at least one polymer being able to impregnate said fibers or said fibrous reinforcement and to form the thermoplastic matrix of said composite material, said composition being characterized in that:
said at least one thermoplastic polymer is a semi-crystalline polyamide polymer with a glass transition temperature Tg of at least 80° C., preferably at least 90° C., and a melting point Tm of less than or equal to 280° C. and a polyaddition polymer between a) at least one thermoplastic polyamide prepolymer, bearing n identical reactive end functions X, chosen from: —NH₂, —CO₂H and —OH, preferably NH₂ and —CO₂H with n being from 1 to 3, preferably from 1 to 2, more preferentially 1 or 2, more particularly 2, and b) at least one chain extender Y-A′-Y, with A′ being a single bond linking the two functions Y or a hydrocarbon-based diradical, of non-polymeric structure and bearing two identical reactive end functions Y, with said functions Y being reactive by polyaddition with at least one function X of said prepolymer a) and preferably with Y being chosen from oxazine, oxazoline, oxazolinone, imidazoline, epoxy, isocyanate, maleimide, cyclic carboxylic anhydride, aziridine and preferably oxazoline or oxazine, and said extender b) having a molecular mass of less than 500, more preferentially a molecular mass of less than 400, and
with said thermoplastic polyamide polymer and its prepolymer a) comprising in their respective structures different amide units A and B and optionally amide units C and D, selected as follows:
   A: is a major amide unit present in a molar content ranging from 55% to 95%, preferably from 55% to 85%, more preferentially from 55% to 80%, chosen from units x.T, where x is a linear aliphatic C₉ to C₁₈ diamine, preferably C₉, C₁₀, C₁₁ and C₁₂ and in which T is terephthalic acid,
   B: is an amide unit different from A, said unit B being present in a molar content ranging from 5% to 45%, preferably from 15% to 45%, more preferentially from 20% to 45%, depending on the Tm of the polyamide based on unit A and said amide unit B is chosen from x′.T units where x′ is chosen from:
   B1) a branched aliphatic diamine bearing a single methyl or ethyl branch (or branching) and having a main chain length different by at least two carbon atoms relative to the main chain length of the diamine x of said associated unit A, preferably x′ being 2-methylpentamethylenediamine (MPMD) or
   B2) m-xylylenediamine (MXD) or
   B3) a linear aliphatic C₄ to C₁₈ diamine when, in the unit A, said diamine x is a linear aliphatic C₁₁ to C₁₈ diamine and x′ is a C₉ to C₁₈ diamine when, in the unit A, said diamine x is a C₉ or C₁₀ diamine,
and preferably, B being chosen from x′.T, where x′ is MPMD according to B1) or MXD according to B2) or a linear aliphatic diamine as defined above according to B3) and more preferentially x′ is MPMD according to B1) or MXD according to B2) and even more preferentially MXD according to B2),
   C: optional amide unit different from A and from B, chosen from amide units based on a cycloaliphatic and/or aromatic structure or based on x′T as defined above for B but with x′ different from x′ for the unit B,
   D: optional amide unit different from A, B and C when C is present and chosen from aliphatic amide units derived from:
      C₆ to C₁₂, preferably C₆, C₁₁ and C₁₂ amino acids or lactams or mixtures thereof
      the reaction of a linear aliphatic C₆ to C₁₈, preferably C₆ to C₁₂ diacid and of a linear aliphatic C₆ to C₁₈, preferably C₆ to C₁₂ diamine, or mixtures thereof
         and under the condition that the sum of the molar contents of A+B+C+D is equal to 100%.

The term “non-reactive” molding composition according to the invention means that said composition is the same as that of the matrix (polyamide) polymer of said composite, since there is an absence of reaction in this composition, which remains stable and unchanging in terms of molecular mass when it is heated for the impregnation of a fibrous reinforcement and the processing of the composite material of the invention. The characteristics of the polyamide polymer in this composition are the same, with Tg and Tm of the polyamide polymer of the thermoplastic matrix of said composite. The number-average molecular mass Mn of said (polyamide) polymer of the thermoplastic matrix of said composite and thus of the polymer of said molding composition is preferably in a range of from 12 000 to 40 000, preferably from 12 000 to 30 000. These Mn values can correspond to inherent viscosities greater than or equal to 0.8. The polyamides according to the invention are non-reactive, either because of the low content of reactive residual functions present, in particular with a content of said functions <120 meq/kg, or because of the presence of end functions of the same type at the chain end which are therefore non-reactive with each other, or because of the modification and blocking of said reactive functions by a monofunctional reactive component, for example for the amine functions by modification reaction with a monoacid or a monoisocyanate and for carboxyl functions by reaction with a monoamine.

Said non-reactive molding composition comprises, in particular in addition to said at least one semi-crystalline polyamide polymer as defined above, at least one fibrous reinforcement, this molding composition more particularly being a composition for a thermoplastic composite material. Said molding composition may also comprise, in addition to said polymer, common fillers and additives that are not reinforcing fibers. Such fillers may be chosen from mineral fillers such as carbonates, pigments and carbon-based fillers. More particularly, said molding composition comprises carbon-based fillers, in particular carbon black or carbon-based nanofillers, these nanofillers preferably being chosen from graphenes and/or carbon nanotubes and/or carbon nanofibrils, or mixtures thereof. More particularly, said composition may comprise said at least one polymer, said fibrous reinforcement and said fillers, in particular said carbon-based nanofillers.

According to a particular option of said polyamide polymer, said amide unit C is present in partial replacement for B in a molar content ranging up to 25% relative to said unit B. Said unit D may also be present and in partial replacement for B in a molar content ranging up to 70% relative to said unit B.

Still as regards said polymer, the difference Tm-Tc, between the melting point Tm and the crystallization temperature Tc of said impregnation polymer that serves as matrix, does not exceed 50° C., preferably does not exceed 40° C., more preferentially does not exceed 30° C. The crystallinity of said polyamide polymer is characterized by the heat of crystallization, measured by differential scanning calorimetry (DSC) according to standard ISO 11357-3, which is preferably greater than 40 J/g and more preferentially greater than 45 J/g. More particularly, said amide unit A is present in a molar content ranging from 55% to 80%, preferably from 55% to 75%, more preferentially from 55% to 70%, relative to all of the units of said polymer.

A first preferred option for said unit B corresponds to x′ T with x′ chosen according to option B1), in particular with x′ being MPMD. According to a second option, said unit B corresponds to x′T with x′ chosen according to option B2), x′ being MXD. According to a third option, said unit B corresponds to a linear aliphatic diamine according to option B3).

According to a more particular option, the units A and B are selected as follows:
for the unit A which is 9T, said unit B is selected from: 10T, 11T, 12T, 13T, 14T, 15T, 16T, 17T and 18T, MPMD.T and MXD.T, preferably 11T, 12T, 13T, 14T, 15T, 16T, 17T and 18T, MPMD.T and MXD.T, more preferentially MPMD.T or MXD.T, with a molar content of B ranging from 30% to 45%
for the unit A which is 10T, said unit B is selected from: 9T, 11T, 12T, 13T, 14T, 15T, 16T, 17T and 18T, MPMD.T and MXD.T, preferably 12T, 13T, 14T, 15T, 16T, 17T and 18T, MPMD.T and MXD.T, more preferentially MPMD.T or MXD.T, with a molar content of B ranging from 25% to 45%
for the unit A which is 11T, said unit B is selected from: 9T, 10T, 12T, 13T, 14T, 15T, 16T, 17T and 18T, MPMD.T and MXD.T, preferably 9T, 13T, 15T, 16T, 17T and 18T, MPMD.T and MXD.T, more preferentially MPMD.T or MXD.T, with a molar content of B ranging from 20% to 45%
for the unit A which is 12T, said unit B is selected from: 9T, 10T, 11T, 13T, 14T, 15T, 16T, 17T and 18T, MPMD.T and MXD.T, preferably 9T, 10T, 14T, 15T, 16T, 17T and 18T, MPMD.T and MXD.T, more preferentially MPMD.T or MXD.T, with a molar content of B ranging from 20% to 45%.

For each choice of A with the corresponding choice of B as mentioned above, a particular option may be defined for the choice of said polymer.

According to another particular option regarding the choice of said polymer, part of the unit B which may range up to 70%, preferably less than 40 mol % relative to B, is replaced with a unit C and/or D as already defined above.

As defined above according to the invention, said polymer of said molding composition used as impregnation polymer for the fibrous reinforcement for the manufacture of a thermoplastic composite material is a polyaddition polymer between at least one prepolymer a) that is reactive via functions X and at least one extender b) that is reactive via functions Y, as already defined above.

Said reactive prepolymers a) preferably have a number-average molecular mass Mn ranging from 500 to 10 000 and preferably from 1000 to 6000.

As regards said extenders b) of structure Y-A′-Y which, by polyaddition reaction with said polyamide prepolymer a), allow the production of said semi-crystalline polyamide polymer used for the melt impregnation of said fibrous reinforcement, mention may be made of suitable examples for obtaining said polymer as follows relative to said function Y.

As regards said extenders b) that are suitable for obtaining said polymer used in the impregnation step i), as examples of chain extenders with oxazoline or oxazine reactive functions Y that may be mentioned, which are suitable for processing the polymer used in the process of the invention, reference may be made to those described under references “A”, “B”, “C” and “D” on page 7 of patent application EP 0 581 642 from the Applicant, and also to the processes for preparing same and the reaction methods that are presented therein. “A” is is bisoxazoline, “B” bisoxazine, “C” is 1,3-phenylene bisoxazoline and “D” is 1,4-phenylene bisoxazoline.

As examples of chain extenders bearing an imidazoline reactive function Y that are suitable for use, reference may be made to those described (“A” to “F”) on pages 7 to 8 and table 1 on page 10 of patent application EP 0 739 924 from the Applicant, and also to the processes for preparing same and the reaction methods presented therein.

As examples of chain extenders bearing a reactive function Y=oxazinone or oxazolinone, reference may be made to those described under references “A” to “D” on pages 7 to 8 of patent application EP 0 581 641 from the Applicant, and also to the processes for preparing same and the reaction methods presented therein.

As examples of oxazinone (6-atom ring) and oxazolinone (5-atom ring) groups Y that are suitable for use, mention may be made of the groups Y derived from: benzoxazinone, from oxazinone or from oxazolinone, with A′ possibly being a covalent single bond with respective corresponding extenders being: bis(benzoxazinone), bisoxazinone and bisoxazolinone.

A′ may also be a C₁ to C₁₄, preferably C₂ to C₁₀, alkylene, but preferably A′ is an arylene and more particularly it may be a phenylene (substituted with Y in positions 1,2 or 1,3 or 1,4) or a naphthalene radical (disubstituted with Y) or a phthaloyl (iso- or terephthaloyl) or A′ may be a cycloalkylene.

For the functions Y such as oxazine (6-membered ring), oxazoline (5-membered ring) and imidazoline (5-membered ring), the radical A′ may be as described above with A′ possibly being a covalent single bond and with the respective corresponding extenders being: bisoxazine, bisoxazoline and bisimidazoline. A′ may also be a C₁ to C₁₄, preferably C₂ to C₁₀, alkylene. The radical A′ is preferably an arylene and more particularly it may be a phenylene (substituted with Y in positions 1,2 or 1,3 or 1,4) or a naphthalene radical (disubstituted with Y) or a phthaloyl (iso- or terephthaloyl) or A′ may be a cycloalkylene.

The presence of a catalyst for the reaction between the prepolymer a) (P(X)n) and the extender Y-A′-Y in a content ranging from 0.001% to 2%, preferably from 0.01% to 0.5%, relative to the total weight of the two co-reactants mentioned, can accelerate the (poly)addition reaction and thus shorten the polyaddition reaction for obtaining said polymer. Such a catalyst may be chosen from: 4,4′-dimethylaminopyridine, p-toluenesulfonic acid, phosphoric acid, NaOH and optionally those described for a polycondensation or transesterification as described in EP 0 425 341, page 9, lines 1 to 7.

More particularly, said extender corresponds to Y chosen from oxazinone, oxazolinone, oxazine, oxazoline and imidazoline, preferably oxazoline and A′ representing a covalent single bond between the two functions Y or an alkylene —(CH₂)ₘ— with m ranging from 1 to 14 and preferably from 2 to 10 or A representing a cycloalkylene or an alkyl-substituted or unsubstituted arylene, in particular benzenic arylenes, from among o-, m- or p-phenylenes or naphthalenic arylenes, A′ preferably being a cycloalkylene or an arylene or A′ being a covalent single bond between the two functions Y.

Said reactive prepolymers a) of the precursor composition for preparing said semi-crystalline polyamide polymer have a number-average molecular mass Mn which may range from 500 to 10 000, preferably from 1000 to 6000.

The weight content of said extender b) in said semi-crystalline polyamide thermoplastic polymer may range, in particular depending on the molecular mass Mn of said prepolymer a), from 1% to 20%, preferably from 5% to 20% by weight.

A chain of said polymer may comprise at least two chains of said prepolymer a) linked together via an extender molecule b) and preferably the number of prepolymer chains a) per chain of said polymer may range from 2 to 80 and more preferably from 2 to 50. The Mn of said polymer may range from 12 000 to 40 000, preferably from 12 000 to 30 000.

According to a particularly preferred option, said prepolymer a) bears X=carboxyl with n=2 (±0.1) and said extender b) bears Y=oxazoline.

More particularly, said semi-crystalline thermoplastic polyamide polymer according to the invention has a repeating unit structure according to formula (I) below:

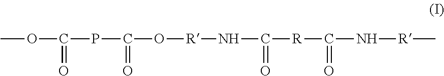

with R being identical to A′ as defined above according to the invention for said extender Y-A′-Y and chosen from a single bond or an optionally substituted aliphatic or cycloaliphatic or aromatic hydrocarbon-based chain,
R′ being an optionally substituted aliphatic or cycloaliphatic or aromatic hydrocarbon-based chain in which the shortest chain linking the neighboring —O— and —NH— units comprises 2 or 3 carbon atoms,
P being the chain of said polyamide prepolymer a) bearing said functions X=carboxyl.

Still as regards said polymer of the invention, said preferred extender b) is chosen from phenylene-bis oxazolines, preferably 1,3-phenylenebis(2-oxazoline) and 1,4-phenylenebis(2-oxazoline).

The melt viscosity of said polymer at the impregnation temperature is preferably <200 Pa·s and more preferentially less than 150 Pa·s.

Preferably, the impregnation temperature is within a range from Tm +10 up to Tm +80° C., more preferentially from Tm +10 to Tm +50° C., with Tm being the melting point of said polyamide polymer.

According to a preferred option, said molding composition comprises a fibrous reinforcement with long fibers, in particular having a circular cross-section with L/D >1000, preferably >2000 and more particularly selected from glass fibers, carbon fibers, ceramic fibers, aramid fibers, or mixtures thereof.

The second subject of the invention relates to a process for manufacturing a thermoplastic composite material, in particular a mechanical part or a structural part based on at least one composition as defined above, said process comprising a step i) of melt impregnation of a fibrous reinforcement with a molding composition, as defined above, but without said fibrous reinforcement or with at least one polymer as defined according to the invention, in an open mold or in a closed mold or not in a mold, and optionally followed by a step ii) of final processing consecutive to or separate from said step i).

In particular, said process may comprise, simultaneously or after an interval, a processing step ii) comprising molding and final forming of said preimpregnated fibrous reinforcement from step i) to form the final composite part in a mold or not in a mold.

More particularly, said processing according to step ii) may be performed according to an RTM, compression injection molding technique, in particular under reduced pressure, pultrusion or by infusion or by thermocompression of a preimpregnate under reduced pressure, also commonly known as the “vacuum bagging technique”. RTM corresponds to resin transfer molding.

The final subject of the invention relates to the use of a composition as defined above according to the invention but without said fibrous reinforcement or the use of a polymer as contained in said composition defined according to the invention for the melt impregnation of a fibrous reinforcement as thermoplastic matrix of a composite material, for the manufacture of mechanical parts or of structural parts of said composite material.

In particular, said mechanical parts or structural parts of said composite material concern applications in the motor vehicle, railway, marine or maritime, wind power or photovoltaic field, the solar energy field, including solar panels and components of solar power stations, the sports, aeronautical and aerospace fields, the road transport field regarding trucks, and the construction, civil engineering, protective panel, leisure, electrical or electronic fields.

More particularly, three more preferred applications can be distinguished according to the temperature at which said parts made of composite material according to the invention are used:
in the wind power field, with a Tg of said thermoplastic matrix polyamide of at least 80° C. and preferably 90° C. or
in the motor vehicle field, with a Tg of said polyamide of at least 100° C. or
in the aeronautical field, with a Tg of said polyamide of at least 120° C.

This means that, for a Tg of at least 100° C., there can be two possible applications: motor vehicle field and wind power field, and if the Tg is at least 120° C., it can have an application in the wind power and motor vehicle fields, in addition to the aeronautical field.

The melt viscosity of the polymer is measured according to the reference manual of the constructor of the measuring instrument used, which is a Physica MCR301 Rheometer, under nitrogen flushing at the temperature given under a shear of 100 s⁻¹, between two parallel planes 50 mm in diameter.

The Mn of the prepolymer or of the thermoplastic polymer is determined from titration (assay) of the end functions X according to a potentiometric method (back-assay of a reagent in excess relative to the OH end functions and direct assay for NH₂ or carboxyl) and from the theoretical functionality n calc (versus X) calculated from the material balance and from the functionality of the reactants. It may also be measured by size exclusion chromatography with PMMA equivalents according to the indication.

Measurement of the intrinsic or inherent viscosity is performed in m-cresol. The method is well known to those skilled in the art. Standard ISO 937 is followed, but with the solvent being changed (use of m-cresol instead of sulfuric acid, and the temperature being 20° C.).

The glass transition temperature Tg of the thermoplastic polymers used is measured using a differential scanning calorimeter (DSC), after a second heating cycle, according to standard ISO 11357-2. The heating and cooling rate is 20° C./min.

The melting point Tm and the crystallization temperature Tc are measured by DSC, after a first heating, according to standard ISO 11357-3. The heating and cooling rate is 20° C./min.

The heat of crystallization of said matrix polymer is measured by differential scanning calorimetry (DSC) according to standard ISO 11357-3.

The examples that follow are presented to illustrate the invention and its performance qualities and do not in any way limit its scope.

### A-1 Preparation of the Reactive Prepolymer P(X)n

5 kg of the following starting materials are placed in a 14-liter autoclave reactor:

500 g of water,

Amines: MXD (m-xylylenediamine) and decanediamine (proportion: see below)

Diacid: T (terephthalic)

35 g of sodium hypophosphite in solution,

0.1 g of a Wacker AK1000 antifoam (the company Wacker Silicones).

The nature and molar ratios of the molecular units and structures of the reactive prepolymer polyamides (by reference test) are given below.

The closed reactor is purged of its residual oxygen and then heated to a temperature of 230° C. of the material. After stirring for 30 minutes under these conditions, the pressurized vapor that has formed in the reactor is gradually reduced in pressure over the course of 60 minutes, while at the same time gradually increasing the temperature of the material such that it becomes established at a minimum Tm +10° C. at atmospheric pressure.

The oligomer (prepolymer) is then emptied out by the bottom valve and then cooled in a water bath and then ground.

The characteristics of the prepolymer obtained are presented below:

Structure (mol % of the units): MXD.T/10.T (41.2/58.8)

function X: carboxyl

meq./kg of X: 621

Mn (potentiometry): 3221

Tg: 119.4° C.

Tm/Tc: 270.3° C./240.8° C.

delta H (ΔH): 50.1 J/g

A-2 Preparation of the Polyamide Polymer According to the Invention by Chain Extension with an Extender of Y-A′-Y Type

10 g of the dried and ground prepolymer presented above are mixed with a stoichiometric amount of 1,3-phenylenebis(2-oxazoline) (PBO).

The mixture is introduced under nitrogen flushing into a DSM co-rotating conical screw microextruder (15 ml volume) preheated to 280° C., with rotation of the screws at 100 rpm. The mixture is left to recirculate in the microextruder and the increase in viscosity is monitored by measuring the normal force. After approximately 2 minutes, a plateau is reached and the contents of the microextruder are emptied out in the form of a rod. The air-cooled product is formed into granules.

The characteristics of said polymer are as follows:

Tg: 135° C.

Tm/Tc: 273° C./230.5° C.

delta H (ΔH): 36 J/g

Mn (SEC): 9900 g/mol in PMMA equivalent

### A-3 Preparation of Comparative PA Without Extender

The comparative polyamides free of PA chain extenders are synthesized according to a protocol similar to that for the reactive prepolymers P(X)n. The Mn is adjusted according to a controlled excess of diacid, according to the method that is well known to those skilled in the art. The amine and diacid components are the same with the same proportions of the components except for the adjustment of the ratio of acid/amine functions to have the targeted Mn comparable to that of the polymer obtained with the extender described above.

The characteristics obtained are presented below:

Structure (mol % of the units): MXD.T/10.T (41.2/58.8)

Tg: 130.7° C.

Tm/Tc: 279.2° C./241.4° C.

delta H (ΔH): 43.6 J/g

Mn (SEC): 10 000 g/mol in PMMA equivalent

A-4 Comparison of the Melt Viscosities Between PA with Extender According to the Invention and the Comparative PA Without Extender

This viscosity was measured at two reference temperatures: 280° C. and 300° C. for the two compared polyamides, with the results presented in the table below, which show that as the temperature increases above the melting point, the viscosity of the polyamide according to the invention decreases much more substantially than that of the comparative polyamide without said chain extender.

| | Melt viscosity polyamide | Melt viscosity comparative |
|---|---|---|
| | according to the invention | polyamide without extender |
| Temperature | (Pa · s) | (Pa · s) |
| 280 | 187 | 189 |
| 300 | 46.2 | 126 |

This greater fluidity of the polyamide according to the invention is an advantage of the invention relative to the prior art in the context of more efficient impregnation of a fibrous reinforcement for the preparation of thermoplastic composite materials with a fibrous reinforcement having said polymer as thermoplastic matrix, with increased mechanical performance of said materials.

1. A non-reactive molding composition comprising at least one thermoplastic polymer and optionally reinforcing fibers or fibrous reinforcement, and, in this case, said at least one polymer being able to impregnate said fibers (or said fibrous reinforcement) and to form the thermoplastic matrix of the composite material:
wherein at least one thermoplastic polymer is a semi-crystalline polyamide polymer with a glass transition temperature Tg of at least 80° C., and a melting point Tm of less than or equal to 280° C. and in that it is a polyaddition polymer between a) at least one thermoplastic polyamide prepolymer, bearing n identical reactive end functions X, chosen from: —NH₂, —CO₂H and —OH, with n being from 1 to 3, and b) at least one chain extender Y-A′-Y, with A′ being a single bond linking the two functions Y or a hydrocarbon-based diradical, of non-polymeric structure and bearing two identical reactive end functions Y, which are reactive by polyaddition with at least one function X of said prepolymer a), and said extender b) having a molecular mass of less than 500,
and
wherein the thermoplastic polyamide polymer and its prepolymer a) comprise in their respective structures different amide units A and B and optionally amide units C and D, selected as follows:
A: is a major amide unit present in a molar content ranging from 55% to 95%, chosen from units x.T, where x is a linear aliphatic C₉ to C₁₈ diamine, and in which T is terephthalic acid,
B: is an amide unit different from A, said unit B being present in a molar content ranging from 5% to 45%, depending on the Tm of the polyamide based on unit A and said amide unit B is chosen from x′.T units where x′ is chosen from:
B1) a branched aliphatic diamine bearing a single methyl or ethyl branch (or branching) and having a main chain length different by at least two carbon atoms relative to the main chain length of the diamine x of said associated unit A, or
B2) m-xylylenediamine (MXD) or
B3) a linear aliphatic C4 to C18 diamine when, in the unit A, said diamine x is a linear aliphatic C₁₁ to C₁₈ diamine and x′ is a C₉ to C₁₈ diamine when, in the unit A, said diamine x is a C₉ or C₁₀ diamine,
C: optional amide unit different from A and from B, chosen from amide units based on a cycloaliphatic and/or aromatic structure or based on x′T as defined above for B but with x′ different from x′ for the unit B,
D: optional amide unit different from A, B and C when C is present and chosen from aliphatic amide units derived from:
C₆ to C₁₂ amino acids or lactams or mixtures thereof
the reaction of a linear aliphatic C₆ to C₁₈, and of a linear aliphatic C₆ to C₁₈,
and under the condition that the sum of the molar contents of A+B+C+D is equal to 100%.

2. The composition as claimed in claim 1, wherein amide unit C is present and in partial replacement for B in a molar content ranging up to 25% relative to said unit B.

3. The composition as claimed in claim 1, wherein unit D is present and in partial replacement for B in a molar content ranging up to 70% relative to said unit B.

4. The composition as claimed in claim 1, wherein the difference Tm-Tc, between the melting point Tm and the crystallization temperature Tc of said matrix polymer, does not exceed 50° C.

5. The composition as claimed in claim 1, wherein the heat of crystallization, measured by differential scanning calorimetry (DSC) according to standard ISO 11357-3, is greater than 40 J/g.

6. The composition as claimed in claim 1, wherein amide unit A is present with a molar content ranging from 55% to 80%, relative to all of the units of said polymer.

7. The composition as claimed in claim 1, wherein unit B corresponds to x′ T with x′ chosen according to option B1).

8. The composition as claimed in claim 1, wherein unit B corresponds to x′ T with x′ chosen according to option B2), x′ being MXD.

9. The composition as claimed in claim 1, wherein unit B corresponds to a linear aliphatic diamine according to option B3).

10. The composition as claimed in claim 1, wherein the units A and B are selected as follows:
for the unit A which is 9T, said unit B is selected from: 10T, 11T, 12T, 13T, 14T, 15T, 16T, 17T and 18T, MPMD.T and MXD.T, with a molar content of B ranging from 30% to 45%,
for the unit A which is 10T, said unit B is selected from: 9T, 11T, 12T, 13T, 14T, 15T, 16T, 17T and 18T, MPMD.T and MXD.T, with a molar content of B ranging from 25% to 45%,
for the unit A which is 11T, said unit B is selected from: 9T, 10T, 12T, 13T, 14T, 15T, 16T, 17T and 18T, MPMD.T and MXD.T, with a molar content of B ranging from 20% to 45%,
for the unit A which is 12T, said unit B is selected from: 9T, 10T, 11T, 13T, 14T, 15T, 16T, 17T and 18T, MPMD.T and MXD.T, with a molar content of B ranging from 20% to 45%.

11. The composition as claimed in claim 10, wherein the unit A is a unit 9T and the unit B is selected from: 10T, 11T, 12T, 13T, 14T, 15T, 16T, 17T and 18T, MPMD.T and MXD.T, with a molar content of B ranging from 30% to 45%.

12. The composition as claimed in claim 10, wherein the unit A is a unit 10T and the unit B is selected from: 9T, 11T, 12T, 13T, 14T, 15T, 16T, 17T and 18T, MPMD.T and MXD.T, with a molar content of B ranging from 25% to 45%.

13. The composition as claimed in claim 10, wherein the unit A is a unit 11T and the unit B is selected from: 9T, 10T, 12T, 13T, 14T, 15T, 16T, 17T and 18T, MPMD.T and MXD.T, with a molar content of B ranging from 20% to 45%.

14. The composition as claimed in claim 10, wherein the unit A is a unit 12T and the unit B is selected from: 10T, 11T, 13T, 14T, 15T, 16T, 17T and 18T, MPMD.T and MXD.T, with a molar content of B ranging from 20% to 45%.

15. The composition as claimed in claim 7, wherein part of the unit B which is up to 70%, is replaced with a unit C and/or D as defined according to one of claims 1 to 3.

16. The composition as claimed in claim 1, wherein reactive prepolymers a) have a number-average molecular mass Mn ranging from 500 to 10,000.

17. The composition as claimed in claim 1, wherein the weight content of said extender in said semi-crystalline polyamide thermoplastic polymer ranges from 1% to 20% by weight.

18. The composition as claimed in claim 1, wherein a chain of the polymer comprises at least two chains of said prepolymer a) linked together via an extender molecule b), the number of prepolymer chains a) per chain of said polymer preferably ranging from 2 to 80.

19. The composition as claimed in claim 1, wherein prepolymer a) bears X=carboxyl and n=2 (±0.1) and in that said extender bears Y=oxazoline.

20. The composition as claimed in claim 19, wherein semi-crystalline thermoplastic polyamide polymer has a repeating unit structure according to formula (I) below: 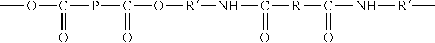
with R being identical to A′ as defined above and chosen from a single bond or an optionally substituted aliphatic or cycloaliphatic or aromatic hydrocarbon-based chain,
R′ being an optionally substituted aliphatic or cycloaliphatic or aromatic hydrocarbon-based chain in which the shortest chain linking the neighboring —O— and —NH— units comprises 2 or 3 carbon atoms,
P being the chain of said polyamide prepolymer a) bearing said functions X=carboxyl.

21. The composition as claimed in claim 19, wherein extender is chosen from phenylene-bisoxazolines.

22. The composition as claimed in claim 1, wherein it comprises a fibrous reinforcement with long fibers.

23. A process for manufacturing a thermoplastic composite material based on at least one composition as defined according to claim 1, wherein the process comprises a step i) of melt impregnation of a fibrous reinforcement with a molding composition, as defined above, but without said fibrous reinforcement or with at least one polymer as defined above, in an open mold or in a closed mold or not in a mold, and optionally followed by a step ii) of final processing consecutive to or separate from said step i).

24. The process as claimed in claim 23, wherein it comprises, simultaneously or after an interval, a processing step ii) comprising molding and final forming of said preimpregnated fibrous reinforcement from step i) to form the final composite part in a mold or not in a mold.

25. The process as claimed in claim 24, wherein processing in step ii) is performed according to an RTM, compression injection molding or pultrusion technique or by infusion or thermocompression of a preimpregnate under reduced pressure.

26. The use of a composition as defined according to claim 1, without said fibrous reinforcement or the use of a polymer as contained in said composition for the bulk melt impregnation of a fibrous reinforcement as thermoplastic matrix of a composite material, for the manufacture of mechanical parts or of structural parts of said composite material.

27. The use as claimed in claim 26 wherein the mechanical parts or structural parts of said composite material concern applications in the motor vehicle, railway, marine or maritime, wind power or photovoltaic field, the solar energy field, including solar panels and components of solar power stations, the sports, aeronautical and aerospace fields, the road transport field regarding trucks, and the construction, civil engineering, protective panel, leisure, electrical and electronic fields.

28. The use as claimed in claim 27, wherein it concerns applications in the wind power field and in that the Tg of said polyamide is at least 80° C.

29. The use as claimed in claim 27, wherein it concerns applications in the motor vehicle field and in that the Tg of said polyamide is at least 100° C.

30. The use as claimed in claim 27, wherein it concerns applications in the aeronautical field and in that the Tg of said polyamide is at least 120° C.
